(19) United States
(12) Patent Application Publication
(10) Pub. No.: US 2017/0167621 A1
(43) Pub. Date: Jun. 15, 2017

(54) SLIDE VALVE

(71) Applicant: PROCESS COMPONENTS LIMITED, Macclesfield (GB)

(72) Inventors: Anthony Goodwin, Macclesfield (GB); Paul Bailey, Macclesfield, Cheshire (GB)

(21) Appl. No.: 15/117,153

(22) PCT Filed: Nov. 7, 2014
(86) PCT No.: PCT/EP2014/074037

§ 371 Date: Aug. 5, 2016

(30) Foreign Application Priority Data
Feb. 7, 2014 (GB) 1402185.1
Feb. 11, 2014 (GB) 1402354.3

(51) Int. Cl. F16K 27/04; F16K 3/316; F16K 3/02

(52) U.S. Cl. CPC F16K 27/044; F16K 3/0281; F16K 3/3165

(57) ABSTRACT

A slide valve is provided and comprises a valve body providing an aperture and a gate (55) reciprocally movable within the body between a first position in which the aperture is occluded and a second position in which the aperture is open to provide a flow path therethrough. The body includes a recess and gate support means (65) are provided in the recess. The gate extends into the recess and is mounted on and moves across the support means between the first and second positions.

The present invention relates generally to a valve and particularly to a slide valve in which a gate or the like is used to selectively open or close a flow path.

Slide valves (which may also be known, for example, as gate valves or orifice valves) generally include a valve body which includes an aperture and a movable gate which is reciprocal between an open and closed position to accommodate flow of material through the valve or to block the flow.

The present invention seeks to provide improvements over known valves.

According to an aspect of the present invention there is provided a slide valve comprising a valve body providing an aperture and a gate reciprocally movable within the body between a first position in which the aperture is occluded and a second position in which the aperture is open to provide a flow path therethrough, in which the gate is mounted on support means and in which the body includes a recess for housing the support means.

A further aspect provides a slide valve comprising a valve body providing an aperture and a gate reciprocally movable within the body between a first position in which the aperture is occluded and a second position in which the aperture is open to provide a flow path therethrough, in which the body includes a recess and gate support means are provided in the recess, in which the gate extends into the recess, and in which the gate is mounted on and moves across the support means between the first and second positions.

By providing a recess in which support means are housed this can be used to afford the support means protection from the product flowing through the body which in many cases may be abrasive (e.g. coal, ash or grain). The gate, blade or the like extends at least partly into the recess so as to be supported on the support means in use.

The gate may be slidably and/or rollingly mounted on the support means. For example the support means may comprise one or more rollers, rolling-element bearings, balls, wheels and the like.

The body may include a seal for sealing against the gate. The seal may be provided in the recess. The seal may be removable from the body, for example the blade seal may be a removable cartridge which can be withdrawn from one end of the body for replacement or repair.

The body may include one or more support or bearing plates for pushing the seal onto the blade. The plate/s may be tapered.

The support means may be connected to the recess. The support means is thereby completely separate from the gate i.e. the support means is not provided on the gate, but rather the gate moves with respect to the support means (e.g. across/over/on top of the support means).

The body may include a pair of opposed recesses, each housing support means. The or each recess on either/both sides of a body may be continuous or discontinuous.

The recess may formed by folds in the body. For example, the body may include a support frame and the recess may be formed in the frame by folds in the material. In some embodiments the body is formed with multiple parts, for example a frame and a housing. This allows for different materials to be used, for example a stainless steel housing and a carbon steel frame.

In some embodiments, by utilising a particular folding of the sheet steel that makes up the frame of the valve body, the moving parts that support the blade are afforded a degree of protection from the flow of material passing through the valve. This solution doesn't interrupt the product flow, retaining the full bore of the valve from inlet to outlet.

The support means may be substantially completely recessed away from the flow path.

The gate may movable between the first and second positions by actuating means, for example a hydraulically or pneumatically actuated piston, or a hand wheel. Alternatively or additionally the gate may be manually movable between the first and second positions.

According to a further aspect there is provided a slide valve comprising a valve body providing an aperture and a gate reciprocally movable within the body between a first position in which the aperture is occluded and a second position in which the aperture is open to provide a flow path, the gate being mounted on support means which are located so as to be recessed away from said flow path.

A further aspect provides a slide valve comprising a valve body providing an aperture and a gate reciprocally movable within the body between a first position in which the aperture is occluded and a second position in which the aperture is open to provide a flow path, the gate being mounted on and movable across support means which are located so as to be recessed away from said flow path.

A further aspect provides a slide valve body providing an aperture and within which a gate is reciprocally movable between a first position in which the aperture is occluded and a second position in which the aperture is open to provide a flow path therethrough, in which the body includes a recess and gate support means are provided and located in the recess, and in which the gate extends into the recess, the gate is mountable on and movable across the support means between the first and second positions in use.

Different aspects and embodiments of the present invention may be used separately or together.

Further particular and preferred aspects of the present invention are set out in the accompanying independent and dependent claims. Features of the dependent claims may be combined with the features of the independent claims as appropriate, and in combination other than those explicitly in the claims.

The present invention will now be more particularly described, by way of example, with reference to the accompanying drawings in which;

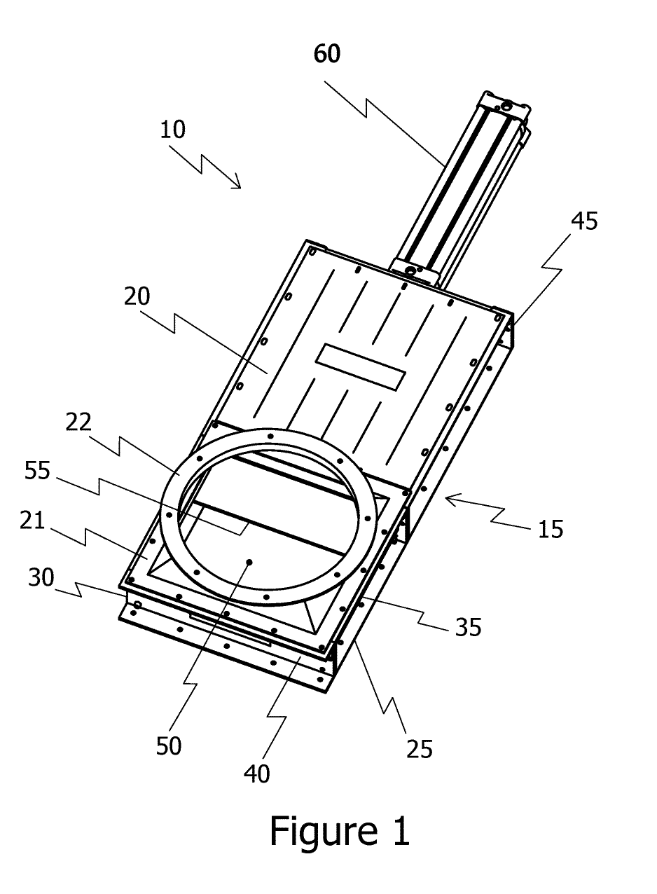

FIG. 1 is a perspective view of a slide valve formed in accordance with the present invention;

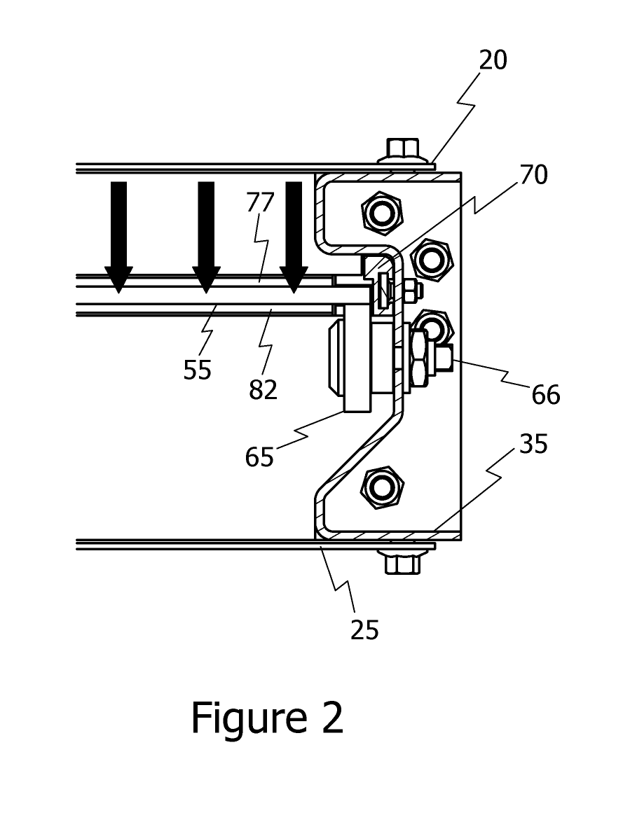

FIG. 2 is a section of the valve of FIG. 1;

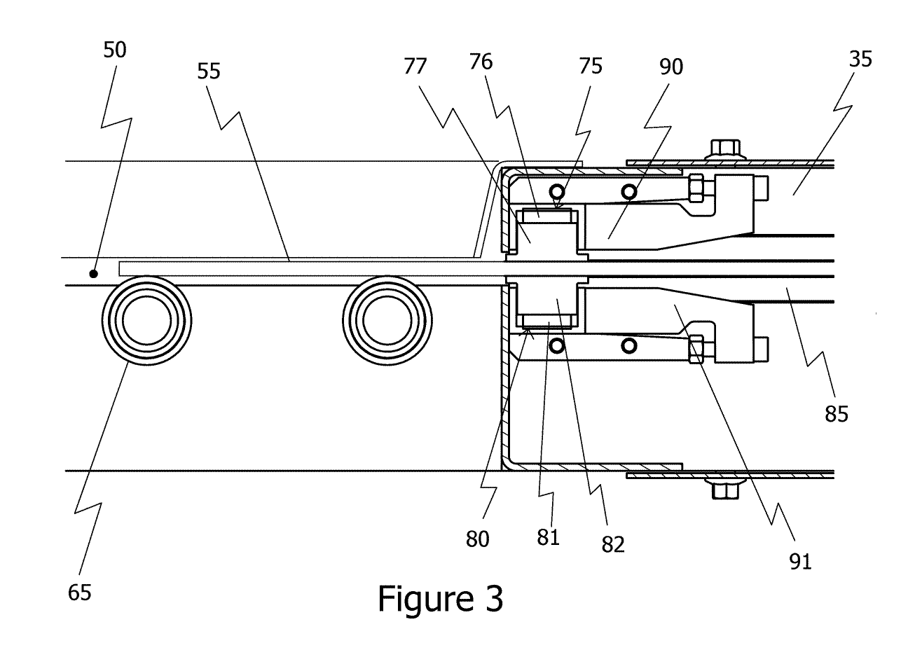

FIG. 3 is a longitudinal section of part of the valve of FIG. 1;

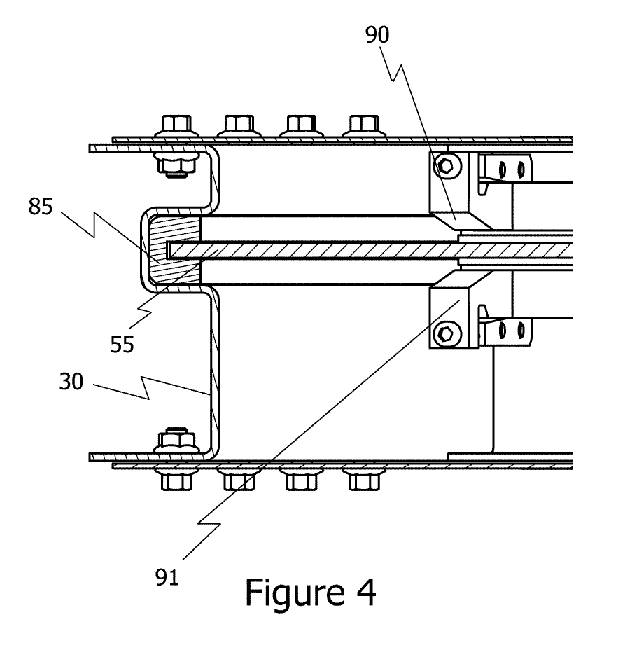

FIG. 4 is a cut-away perspective view of part of the valve of FIG. 1;

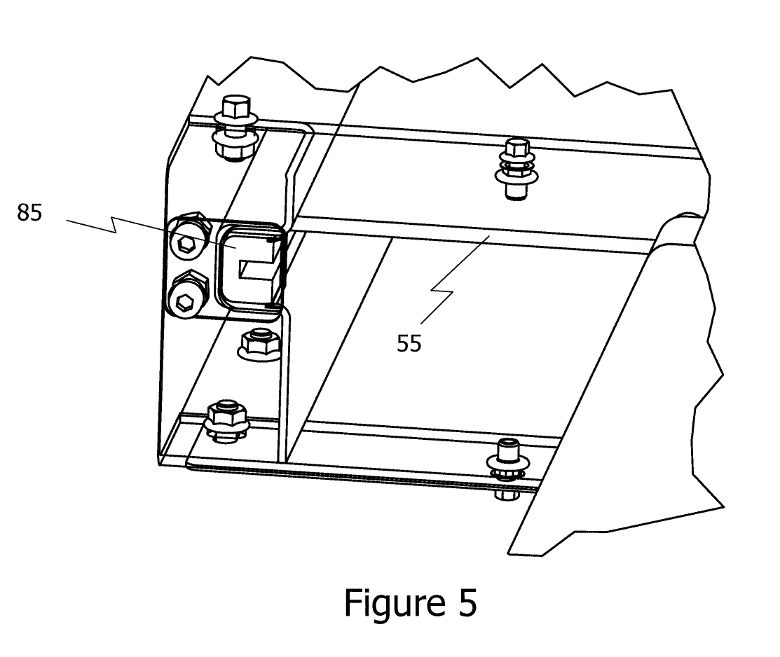

FIG. 5 shows part of one end of the valve of FIG. 1;

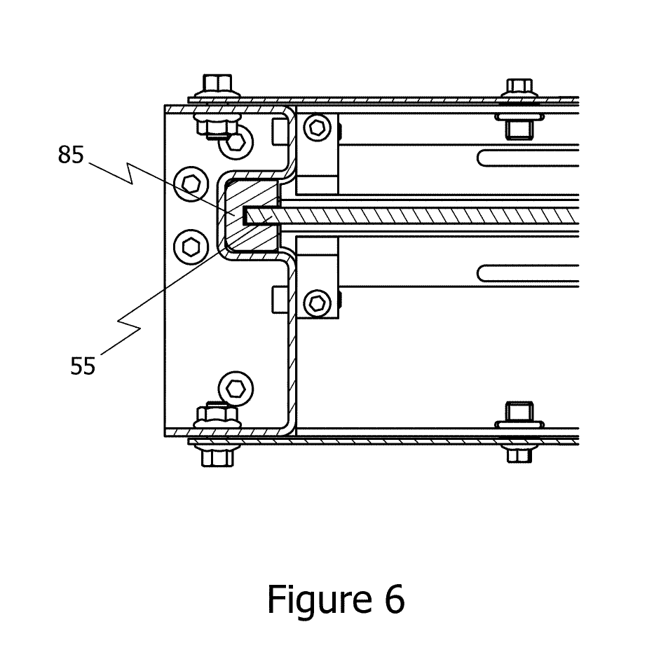

FIG. 6 is a section of the end of FIG. 5; and

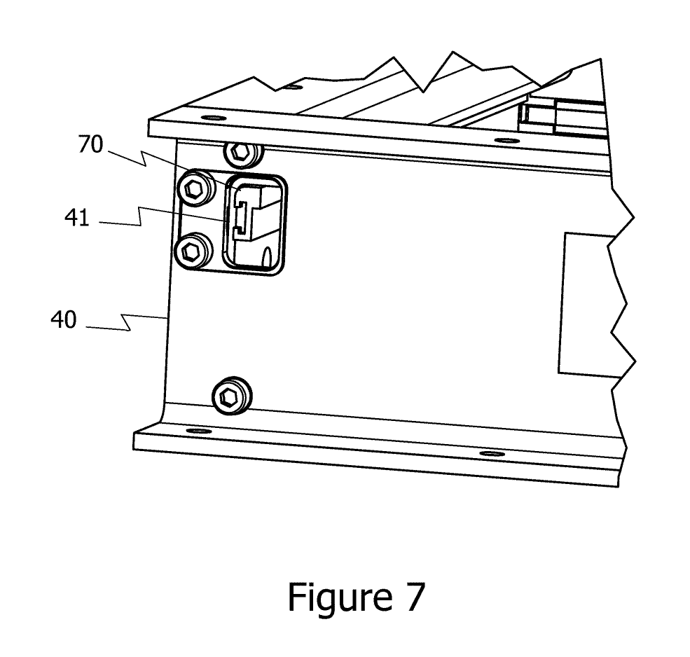

FIG. 7 is a perspective view of the other end of the valve of FIG. 1.

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

Referring first to FIG. 1 there is shown a slide valve generally indicated 10.

The valve 10 comprises a generally rectangular body 15 with opposed top and bottom plates 20, 25, opposed folded sidewalls 30, 35 and opposed front and rear walls 40, 45.

Between the top plate 20 and the front wall 40 is a rectangular gap into which is fitted a square aperture frame 21. In this embodiment the frame 21 is fitted with a round-to-square adapter having a central circular aperture ring 22 defining an aperture 50. The bottom of the body is provided with a similar arrangement so that the aperture 50 extends through the body.

A movable blade or gate 55 is provided in the body. The blade can slide so as to close the aperture (as it approaches the front wall 40) or open the aperture (as it is withdrawn towards the rear wall 45). In FIG. 1 the blade 55 is shown in a partially closed position across the aperture. A piston 60 is attached to the rear wall 45 for causing the blade to move in this manner.

In FIG. 2 the top and bottom panels 20, 25 are shown and the sidewall 35 is shown between them. The sidewall 35 has an internal recess 36 within which are housed a set (in this embodiment two, but in other embodiments one or more may be used) of rollers. Each roller 65 is rollingly connected to the recess wall by an off-centre shaft 66 (which may also be referred to as a bearing journal support). This means that the height of the roller can be adjusted by turning it; then it can be locked in position.

The blade 55 can roll across the rollers 65 between the open and closed positions. The blade extends into the recess and an inverted L-shape guide strip 70 helps to ensure the blade moves smoothly and is centralised (there being the same arrangement on the other side of the body in the wall 30). The strip 70 is also shown in FIG. 7, in which the front wall 40 is shown to include an access port 41. In this embodiment the strip can be removed through the port 41 for replacement or repair.

It will be seen from FIG. 2 that by locating the rollers in the recess 36 they are away from the flow path and therefore shielded from the flow of material. Furthermore, all of the aperture is used for product flow as the rollers do not impinge on the usable area.

In FIG. 3 a pair of opposed “top hat” shape sealing members 75, 80 are shown. Each member comprises an elastomeric block 76, 81 and a polymeric sealing plate 77, 82. The plates 77, 82 contact either side of the blade and the blocks 76, 81 press them down onto the blade to ensure a good seal and can compensate for plate wear. Tapered blocks 90, 91 are used to retain the members 75, 80.

FIGS. 4 to 6 show a further U-section guide strip 85 in which the blade sits. The strip 85 helps to guide the blade in use.

In this embodiment all of the guides and seals can be removed for replacement or repair.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

1. A slide valve comprising a valve body providing an aperture extending through the valve body and a gate reciprocally movable within the valve body between a first position in which the aperture is occluded and a second position in which the aperture is open to provide a flow path therethrough, wherein the valve body includes a recess in which gate support means is housed, the gate support means being separate from the gate, and the gate extends into the recess and is mounted on and moves with respect to the gate support means between the first and second positions, and wherein a sidewall of the valve body fully defines the recess and a side of the aperture through the valve body, the sidewall being a single continuous element.

2. A valve as claimed in claim 1, in which the support means is connected to the recess.

3. A valve as claimed in claim 1, in which the gate is slidably and/or rollingly mounted on the support means.

4. A valve as claimed in claim 1, in which the support means comprises one or more rollers, rolling element bearings, balls, or wheels.

5. A valve as claimed in claim 4, in which the support means comprises one or more rollers and in which the or each roller is rollingly connected to the recess wall by an off-center shaft.

6. A valve as claimed in claim 1, in which the body includes a seal for sealing against the gate.

7. A valve as claimed in claim 6, in which the seal is provided in the recess.

8. A valve as claimed in claim 6, in which the seal is removable from the body.

9. A valve as claimed in claim 6, in which the body includes one or more bearing plates for pushing the seal onto the gate.

10. A valve as claimed in claim 9, in which the plate/s is tapered.

11. A valve as claimed in claim 1, in which the body includes a pair of opposed recesses, each housing support means.

12. A valve as claimed in claim 1, in which the recess is formed by folds in the body.

13. A valve as claimed in claim 1, in which the support means are substantially completely recessed away from the flow path.

14. A valve as claimed in claim 1, further comprising actuating means for moving the gate between the first and second positions.

15. (canceled)

16. A valve as claimed in claim 1, in which the body includes a support frame, in which the recess/es are formed.

17-18. (canceled)

19. A slide valve body providing an aperture extending through the slide valve body and within which a gate is reciprocally movable between a first position in which the aperture is occluded and a second position in which the aperture is open to provide a flow path therethrough, the slide valve body including a recess and gate support means for supporting a gate in use, the gate support means being housed in the recess and separate from a gate in use, wherein a gate in use is mounted on and moves with respect to the gate support means between the first and second positions, and wherein a sidewall of the slide valve body fully defines the recess and a side of the aperture through the slide valve body, the sidewall being a single continuous element.

20. (canceled)
